(19) United States
(12) Patent Application Publication
(10) Pub. No.: US 2025/0253971 A1
(43) Pub. Date: Aug. 7, 2025

(54) RADIO COMMUNICATION SYSTEM, RADIO COMMUNICATION METHOD, AND RADIO COMMUNICATION DEVICE

(71) Applicant: NIPPON TELEGRAPH AND TELEPHONE CORPORATION, Tokyo (JP)

(72) Inventors: Hitoshi HASEGAWA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/835,081

(22) PCT Filed: Feb. 9, 2022
(86) PCT No.: PCT/JP2022/005147

§ 371 Date: Aug. 1, 2024

(51) Int. Cl. H04L 1/00; H04W 76/10

(52) U.S. Cl. CPC H04L 1/0003; H04W 76/10

(57) ABSTRACT

The present disclosure relates to a wireless communication system suitable for stably securing a transmission capability in a multiplex transmission scheme using a plurality of channels, and an object thereof is to secure a desired transmission capacity even though some channels become unusable. The wireless communication device and the communication partner device establish communication by using a plurality of channels in a multiplexed manner, and each of the wireless communication device and the communication partner device has a function responding to a change of a modulation scheme used for wireless communication. The wireless communication device detects an occurrence of an unusable state for each of the plurality of channels. When the unusable state is detected, the working modulation scheme is changed to another modulation scheme that generates a larger transmission capacity to secure a desired transmission capacity in a usable channel.

### TECHNICAL FIELD

The present disclosure relates to a radio communication system, a radio communication method, and a radio communication device, and more particularly, to a radio communication system, a radio communication method, and a radio communication device suitable for stably securing a transmission capability in a multiplex transmission scheme using a plurality of channels.

### BACKGROUND ART

The following Patent Literature 1 discloses a technique related to a virtual concatenation transmission system. More specifically, Patent Literature 1 discloses a technique of constructing a virtual concatenation group (VCG) having a high degree of freedom and efficiency by constructing the VCG in a manner of mixing a plurality of types of paths having different transmission rates on a time division multiplexing line that performs synchronous transfer, such as a synchronous digital hierarchy (SDH)/synchronous optical network (SONET) network.

### CITATION LIST

### Patent Literature

Patent Literature 1: JP 2007-13390 A

### SUMMARY OF INVENTION

### Technical Problem

By the way, as disclosed in Patent Literature 1, in a device that realizes large-capacity transmission by multiplexing of a plurality of wireless channels, when it is not possible to use some channels due to radio wave interference or failure, the operation is continued on the remaining channels. In this case, the operation has to be continued in a band smaller than the originally necessary band.

Then, if it is not possible to secure the originally necessary band, the packet loss occurs in a portion exceeding the band. If the packet loss occurs, it is not possible to secure the quality of a service accommodated in a line, and for example, problems such as interruption of a call in a telephone service and disturbance of a video in a video service occur.

The present disclosure has been made in view of the above problems, and a first object of the present disclosure is to provide a wireless communication system capable of stably securing a desired transmission capacity even though some channels become unusable, while securing a desired transmission capacity by multiplexing of a plurality of wireless channels.

In addition, a second object of the present disclosure is to provide a wireless communication method for stably securing a desired transmission capacity even though some channels become unusable, while securing a desired transmission capacity by multiplexing a plurality of wireless channels.

Further, a third object of the present disclosure is to provide a wireless communication device capable of stably securing a desired transmission capacity even though some channels become unusable, while securing a desired transmission capacity by multiplexing a plurality of wireless channels.

### Solution to Problem

To achieve the above objects, according to a first aspect, desirably, a wireless communication system includes a wireless communication device and a communication partner device that establish communication by multiplexing and using a plurality of channels. Each of the wireless communication device and the communication partner device has a function responding to a change of a modulation scheme used for wireless communication. The wireless communication device is configured to
execute a process of detecting an occurrence of an unusable state for each of the plurality of channels,
a scheme change process of changing a working modulation scheme to another modulation scheme that generates a larger transmission capacity in a case where the unusable state is detected, and
a process of notifying the communication partner device of the change. The communication partner device is configured to receive the notification and change the modulation scheme to the other modulation scheme.

Further, according to a second aspect, desirably, there is provided a wireless communication method using a wireless communication device and a communication partner device that establish communication by using a plurality of channels in a multiplexed manner. Each of the wireless communication device and the communication partner device has a function responding to a change of a modulation scheme used for wireless communication. The wireless communication method includes
a step of detecting an occurrence of an unusable state for each of the plurality of channels;
a scheme change step of changing a working modulation scheme to another modulation scheme that generates a larger transmission capacity in a case where the unusable state is detected; and
a step of causing the wireless communication device and the communication partner device to share the change.

Further, according to a third aspect, desirably, a wireless communication device establishes communication with a communication partner device by using a plurality of channels in a multiplexed manner, the wireless communication device being configured to execute
a process of detecting an occurrence of an unusable state for each of the plurality of channels,
a scheme change process of changing a working modulation scheme to another modulation scheme that generates a larger transmission capacity in a case where the unusable state is detected, and
a process of notifying the communication partner device of the change.

### Advantageous Effects of Invention

According to the first to third aspects, it is possible to stably secure a transmission capacity secured by multiplexing of a plurality of wireless channels even in a situation in which some channels become unusable.

### BRIEF DESCRIPTION OF DRAWINGS

FIG. 1 is a diagram for describing a feature operation of a wireless communication system according to a first embodiment of the present disclosure.

FIG. 2 is a block diagram for describing a configuration of a wireless communication device used in the wireless communication system in the first embodiment of the present disclosure.

FIG. 3 is a flowchart for describing a flow of main processing performed in the wireless communication device illustrated in FIG. 2.

### DESCRIPTION OF EMBODIMENTS

### First Embodiment

### Feature of First Embodiment

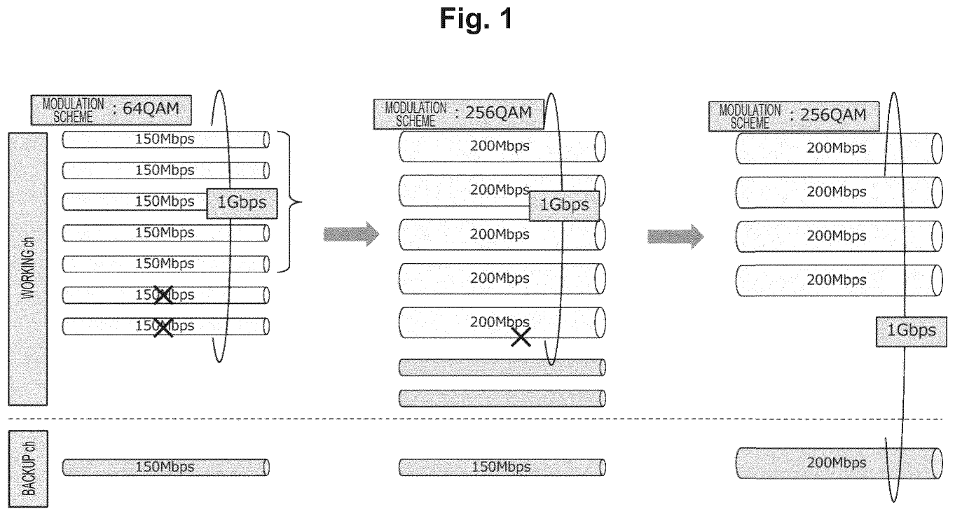

FIG. 1 is a diagram for describing a feature of a wireless communication system according to a first embodiment of the present disclosure. A region in an upper part divided by a horizontal broken line represents an image of a plurality of wireless channels assumed to be used in a normal time. These channels are referred to below as “working channels”. On the other hand, a region in a lower part of FIG. 1 represents an image of a backup channel that is not used in the normal time.

An image on the left side of FIG. 1 represents a primary state used in the wireless communication system in the present embodiment. In the primary state, seven working channels and one backup channel are prepared as illustrated in FIG. 1. “64 quadrature amplitude modulation (QAM)” is used as a modulation scheme of a wireless signal, and a transmission capacity of 150 Mbps is provided for each channel. The wireless communication system in the present embodiment requires a transmission capacity of 1 Gbps, and such a transmission capacity can be secured by operating the seven working channels.

Two cross marks in the image in the upper left part of FIG. 1 represent that the corresponding channel is in an unusable state. For example, such a situation may occur due to a failure of a device that transmits a wireless signal, interference in a frequency band used by these channels, or the like. In this case, only by operating five working channels as they are, the transmission capacity that can be secured is 750 Mbps, and it is not possible to satisfy the requirement of 1 Gbps.

The image in the center of FIG. 1 indicates a secondary state used in the wireless communication system in the present embodiment in order to satisfy the requirement of 1 Gbps under such a situation. In this state, as illustrated in FIG. 1, the modulation scheme is changed from “64QAM” to “256QAM”. As a result, the transmission capacity of each of the five operable working channels is increased to 200 Mbps, and the transmission capacity in the entirety of the system satisfies the requirement of 1 Gbps.

When the wireless communication system is operated in a configuration in which the maximum performance is exhibited, the performance decreases under an environment such as a stormy weather, and a situation in which the transmission capacity changes frequently may occur. Since it is preferable that the transmission capacity provided by the same communication service does not change as much as possible, it is desirable to secure a margin to some extent with respect to the maximum setting allowed by the hardware. Then, in the present embodiment, such a configuration having a margin is used in the primary state. Therefore, in the secondary state, the modulation scheme can be changed to “256QAM” in which the higher performance is exhibited, and thus the requirement of 1 Gbps can be satisfied even under an environment where two channels are unusable.

In the secondary state illustrated in the center of FIG. 1, when another one channel turns into an unusable state, the number of operable working channels becomes four, and thus a situation in which it is not possible to satisfy the requirement of 1 Gbps occurs again. An image on the right side of FIG. 1 indicates a tertiary state adopted by the wireless communication system in the present embodiment under such a situation.

In the tertiary state, the backup channel is used in addition to the four operable working channels. In the primary state, it is assumed that the backup channel is also used at 150 Mbps, but in the tertiary state, 256QAM is used as the modulation scheme, and thus the transmission capacity thereof is 200 Mbps. As a result, the requirement of 1 Gbps can be satisfied by the four working channels and the one backup channel.

As described above, the wireless communication system in the present embodiment secures a large transmission capacity by using a plurality of working channels in a multiplexed manner in the normal time. Then, in a case where some of the working channels are in an unusable state, first, the modulation scheme is changed to aim to secure a desired transmission capacity by the operable working channels. Then, when it is not possible to secure the desired capacity only by the working channels, it is aimed to secure a further capacity by using the backup channel. Thus, according to this system, even though some channels become unusable, it is possible to stably secure a desired transmission capacity.

### Configuration of First Embodiment

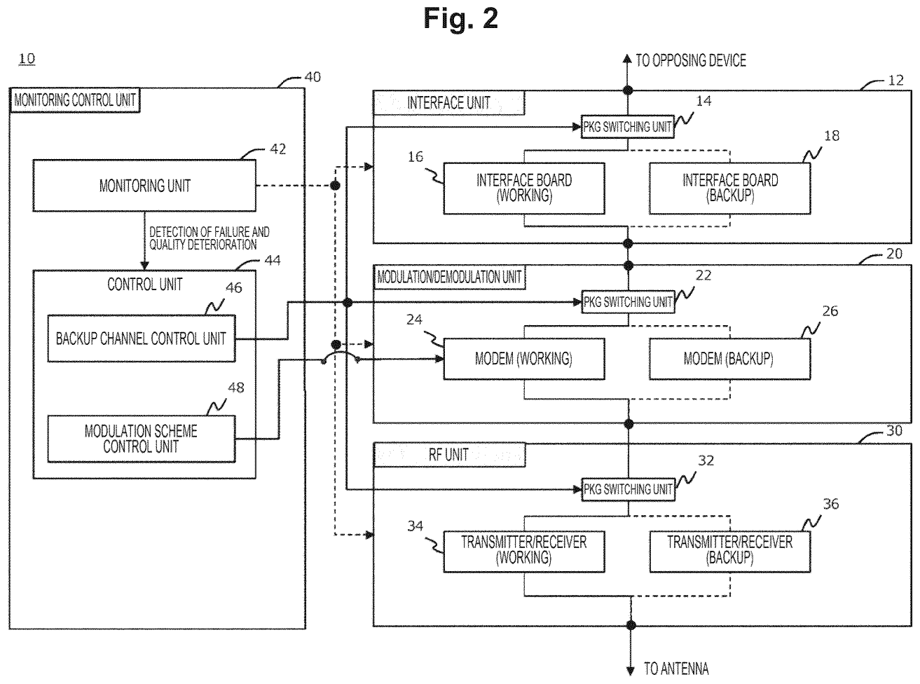

FIG. 2 is a block diagram for describing a configuration of a wireless communication device 10 used in the wireless communication system in the present embodiment. The wireless communication device 10 has a function of transmitting a large amount of data by simultaneously using a plurality of wireless channels. The configuration described below can be made by an electronic circuit using dedicated hardware. In addition, a memory storing a program and a processing unit may be combined with dedicated hardware, and the processing unit is caused to execute the program, thereby realizing some processes.

The wireless communication device 10 includes an interface unit 12. The interface unit is connected to an opposing device (not illustrated). The wireless communication device 10 can transmit and receive information to and from the opposing device via a wired transmission path connected to the interface unit 12. The interface unit 12 includes a PKG switching unit 14, an interface board (working) 16, and an interface board (backup) 18.

The interface board (working) 16 incorporates an interface for the working channel. For example, in a case where seven working channels are prepared as illustrated in FIG. 1, an interface corresponding to each of the working channels is prepared.

The interface board (backup) 18 incorporates an interface for the backup channel. Similar to the case of the working channel, interfaces of which the number is equal to the number of backup channels are also prepared in the interface board (backup) 18. If there is only one backup channel as illustrated in FIG. 1, one interface is incorporated in the interface board (backup) 18.

The PKG switching unit 14 is an element that performs switching between a working package and a backup package. Specifically, in a case where some of the working channels become unusable, the PKG switching unit 14 appropriately switches the states of the interface board (working) 16 and the interface board (backup) 18 so that the working channel is replaced with the backup channel.

The interface unit 12 is connected to a modulation/demodulation unit 20. The modulation/demodulation unit 20 includes a PKG switching unit 22, a MODEM (working) 24, and a MODEM (backup) 26. The PKG switching unit 22 performs switching between the MODEM (working) 24 and the MODEM (backup) 26 in conjunction with the PKG switching unit 14 of the interface unit 12. The MODEM (working) 24 modulates and demodulates a signal transmitted by using the working channel. On the other hand, the MODEM (backup) 26 modulates and demodulates a signal transmitted by using the backup channel.

A signal processed by the MODEM (working) 24 or the MODEM (backup) 26 is provided for a radio frequency (RF) unit 30. The RF unit 30 includes a PKG switching unit 32, a transmitter/receiver (working) 34, and a transmitter/receiver (backup) 36. The PKG switching unit 32 performs switching between the transmitter/receiver (working) 34 and the transmitter/receiver (backup) 36 in conjunction with the two PKG switching units 14 and 22 described above. Both the transmitter/receiver (working) 34 and the transmitter/receiver (backup) 36 are connected to an antenna for transmitting and receiving wireless signals. The transmitter/receiver (working) 34 executes a process necessary for transmitting and receiving a wireless signal via the antenna by the working channel. On the other hand, the transmitter/receiver (backup) 36 executes a similar process in order to transmit and receive a wireless signal via the antenna by the backup channel.

The wireless communication device 10 in the present embodiment further includes a monitoring control unit 40. The monitoring control unit 40 includes a monitoring unit 42. The monitoring unit 42 monitors the state of each of the interface unit 12, the modulation/demodulation unit 20, and the RF unit 30. When any of the plurality of working channels turns into an unusable state by an influence of failure or interference, the state is detected by the monitoring unit 42. When detecting a failure or deterioration in communication quality, the monitoring unit 42 provides information regarding the detection for a control unit 44.

The control unit 44 includes a backup channel control unit 46 and a modulation scheme control unit 48. When receiving information indicating that the specific working channel is unusable from the monitoring unit 42, the modulation scheme control unit 48 executes a process for changing the modulation scheme to a modulation scheme in which the higher performance than the working modulation scheme can be exhibited. If the modulation scheme can be changed, a change request command is issued from the modulation scheme control unit 48 to the MODEM (working) 24. As a result, for example, the scheme of 64QAM is changed to 256QAM, and the transmission capacity of each operable working channel is increased.

When the number of unusable working channels is large and it is not possible to secure a desired transmission capacity by the change of the modulation scheme, a command to use the backup channel is transmitted from the backup channel control unit 46 to the PKG switching units 14, 22, and 32. As a result, the tertiary state in which the backup channel is used is realized, and the transmission capacity of the wireless communication device 10 is improved.

### Flow of Processing in First Embodiment

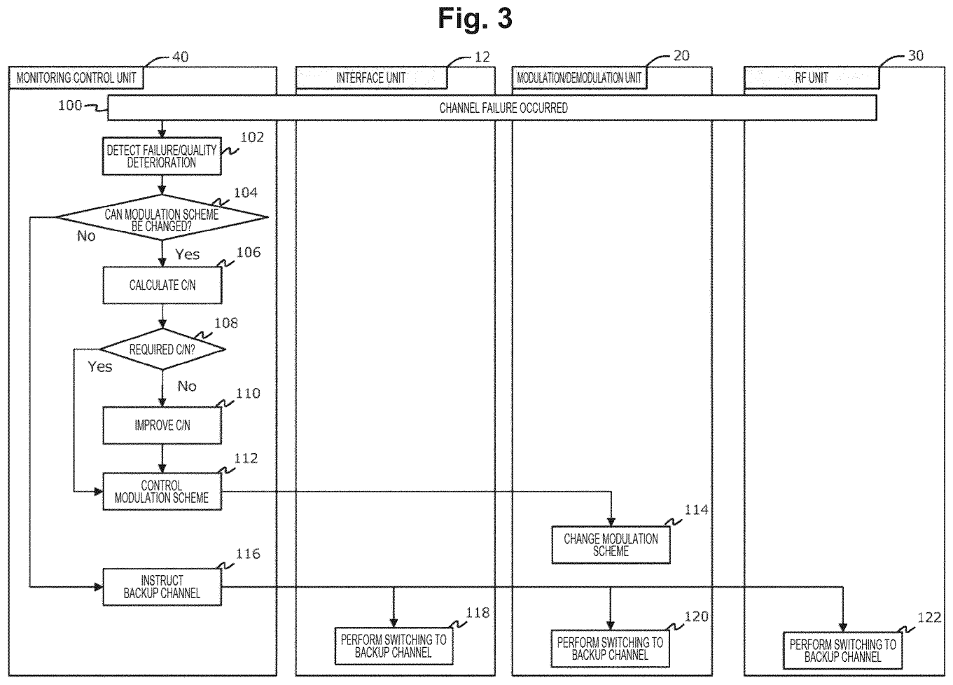

A flow of processing performed by the wireless communication device 10 in the present embodiment will be described below in more detail with reference to FIG. 3. FIG. 3 is a flowchart for describing the flow of main processing performed in the wireless communication device 10.

When any of a plurality of multiplexed working channels turns into an unusable state by an influence of failure or the like (Step 100), the failure or quality deterioration is detected in the monitoring control unit 40 (Step 102). In this case, the monitoring control unit 40 first determines whether or not the modulation scheme can be increased from the current operation value (Step 104).

In a case where the modulation scheme is not an upper limit value, it can be determined that the modulation scheme can be changed. In this case, then, the monitoring control unit 40 calculates a C/N value that is an intensity ratio between a carrier wave and noise, which are included in a wireless signal received from the antenna (Step 106).

For example, in order to change the modulation scheme from 64QAM to 256QAM by changing the modulation scheme to a higher-speed (broadband) modulation scheme, it is necessary to secure C/N for obtaining sufficient communication quality by the changed modulation scheme. Therefore, the monitoring control unit 40 determines whether or not the current C/N satisfies the required C/N required for the changed modulation scheme (Step 110).

As a result, in a case where it is determined that the current C/N does not satisfy the required C/N, the monitoring control unit 40 then executes a process for improving the C/N value (Step 110). Specifically, for example, a process of requesting an increase in transmission output via a wireless transmission path is executed on a communication partner device that is a transmission source of a wireless signal. If the transmission device increases the transmission output of the wireless signal in response to the request, the C/N can be improved, and a situation in which the improved C/N satisfies the required C/N can be created.

In a case where it is determined in Step 108 that the required C/N is satisfied, and after issuing a C/N improvement request for satisfying the required C/N in Step 110, the monitoring control unit 40 performs modulation scheme switching control (Step 112). Specifically, the modulation/demodulation unit 20 is requested to switch the modulation scheme.

Upon receiving the request, the modulation/demodulation unit 20 changes the modulation scheme to increase the transmission capacity. For example, the scheme of 64QAM is changed to 256QAM. In addition, the communication partner device that has established wireless communication with the wireless communication device 10 is notified of information regarding the change of the modulation scheme (Step 114). As described above, in a case where the C/N value may satisfy the required C/N, the wireless communication device 10 in the present embodiment changes the modulation scheme to a higher-speed (broadband) modulation scheme to improve the transmission speed per channel and compensate for the insufficient band due to the failure.

Further, in a case where a channel failure has occurred (Step 100) and it is not possible to change the modulation scheme to a higher-speed (wideband) modulation scheme any more (Step 104), the wireless communication device 10 issues an instruction to switch the working channel in which the failure has occurred to the backup channel (Step 116). This instruction is provided for the interface unit 12, the modulation/demodulation unit 20, and the RF unit 30. As a result, the settings of the PKG switching units 14, 22, and 32 are switched, and the communication partner device of the wireless communication is notified of information regarding the switching (Steps 118, 120, and 122). As a result, a state in which compensation for the insufficient bandwidth is performed by the backup channel is realized. In order to use the backup channel, equipment for the backup channel is required. Thus, in the present embodiment, the modulation scheme is preferentially changed from the viewpoint of cost, and the backup channel is used as a suboptimal measure.

As described above, according to the wireless communication system in the present embodiment, in a case where failure or the like have occurred in some of the plurality of working channels used in a multiplexed manner, it is possible to appropriately adopt measures such as a change of the modulation scheme, a change of the modulation scheme after improving the C/N, and use of the backup channel. As a result, according to the present system, it is possible to stably secure the quality of a communication service by appropriately maintaining a transmission band at the time of failure of the multiplexed channels.

### Modification of First Embodiment

Meanwhile, in the first embodiment described above, the wireless communication device 10 is connected to the opposing device that is an information providing source via the wired transmission path, but the present disclosure is not limited thereto. The wireless communication device 10 may establish communication with the opposing device via a wireless transmission path by multiplexing of a plurality of channels. In addition, in this case, the above-described method for coping with failure or the like may also be applied to the wireless transmission path to the opposing device.

Further, in the first embodiment described above, the backup channel is prepared in the wireless transmission path, but the present disclosure is not limited thereto. Coping with the failure or the like may be performed only by changing the modulation scheme without preparing the backup channel.

In addition, in the first embodiment described above, the C/N is improved before the modulation scheme is changed, but the C/N is not necessarily improved. The process of improving the C/N may not be executed, and the modulation scheme may be changed only in a case where the current C/N satisfies the required C/N. In a case where the required C/N is not satisfied, the backup channel may be used at this time.

In addition, in the first embodiment described above, in a case where failure or the like of the working channel are detected, the C/N is calculated to determine whether or not the required C/N has been secured, but these processes are also not essential. For example, regarding the C/N, the modulation scheme may be changed without calculating the C/N on the assumption that the required C/N may be satisfied.

Furthermore, in the first embodiment described above, in Step 110 illustrated in FIG. 3, after the process for improving the C/N is executed, the process of Step 112 of changing the modulation scheme without a condition is executed. However, the present disclosure is not limited thereto. For example, after Step 110 is executed, the process of Step 112 may be executed only in a case where the required C/N is obtained. In a case where the required C/N is not obtained, the process may return to Step 104 to switch the policy to using the backup channel.

### REFERENCE SIGNS LIST

10 Wireless communication device
12 Interface unit
20 Modulation/demodulation unit
30 RF unit
40 Monitoring control unit
42 Monitoring unit
44 Control unit
46 Backup channel control unit

1. A wireless communication system comprising:
a wireless communication device circuitry and a communication partner device circuitry that establish communication by using a plurality of channels in a multiplexed manner, wherein
each of the wireless communication device circuitry and the communication partner device circuitry has a function responding to a change of a modulation scheme used for wireless communication,
the wireless communication device circuitry is configured to execute:
detecting an occurrence of an unusable state for each of the plurality of channels;
changing a working modulation scheme to another modulation scheme that generates a larger transmission capacity in a case where the unusable state is detected; and
notifying the communication partner device circuitry of the change; and
the communication partner device circuitry is configured to receive the notification and change the modulation scheme to the another modulation scheme.

2. The wireless communication system according to claim 1, wherein
the plurality of channels includes a plurality of working channels assumed to be used in a normal time and at least one backup channel assumed to be used as backup, and
the wireless communication device circuitry is configured to:
not instruct use of the backup channel during a period in which a working channel capacity that is a sum of transmission capacities of usable working channels satisfies a desired transmission capacity by a change of the modulation scheme;
determine whether or not the change of the modulation scheme, which causes achievement of the working channel capacity that satisfies the desired transmission capacity, is possible; and
instruct use of the backup channel in a case where the determination is denied.

3. The wireless communication system according to claim 1, wherein
the wireless communication device circuitry is configured to execute:
enhancing C/N that is an intensity ratio between a carrier wave and noise which are included in a wireless signal transmitted and received to and from the communication partner device circuitry, in a case where the unusable state is detected; and
the working modulation scheme is changed to the another modulation scheme after the enhancement of the C/N is executed.

4. The wireless communication system according to claim 3, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the enhancement of the C/N is executed in a case where the current C/N does not satisfy the required C/N.

5. The wireless communication system according to claim 4, wherein the wireless communication device circuitry is configured to change the working modulation scheme to the another modulation scheme in a case where C/N satisfying the required C/N is obtained as a result of the enhancement of the C/N.

6. The wireless communication system according to claim 1, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

7. A wireless communication method using a wireless communication device circuitry and a communication partner device circuitry that establish communication by using a plurality of channels in a multiplexed manner,
each of the wireless communication device circuitry and the communication partner device circuitry having a function responding to a change of a modulation scheme used for wireless communication, the wireless communication method comprising:
detecting an occurrence of an unusable state for each of the plurality of channels;
changing a working modulation scheme to another modulation scheme that generates a larger transmission capacity in a case where the unusable state is detected; and
causing the wireless communication device circuitry and the communication partner device circuitry to share the change.

8. A wireless communication device circuitry that establishes communication with a communication partner device circuitry by using a plurality of channels in a multiplexed manner, the wireless communication device circuitry being configured to execute:
detecting an occurrence of an unusable state for each of the plurality of channels;
changing a working modulation scheme to another modulation scheme that generates a larger transmission capacity in a case where the unusable state is detected; and
notifying the communication partner device circuitry of the change.

9. The wireless communication system according to claim 2, wherein
the wireless communication device circuitry is configured to execute:
enhancing C/N that is an intensity ratio between a carrier wave and noise which are included in a wireless signal transmitted and received to and from the communication partner device circuitry, in a case where the unusable state is detected; and
the working modulation scheme is changed to the another modulation scheme after the enhancement of the C/N is executed.

10. The wireless communication system according to claim 9, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the enhancement of the C/N is executed in a case where the current C/N does not satisfy the required C/N.

11. The wireless communication system according to claim 10, wherein the wireless communication device circuitry is configured to change the working modulation scheme to the another modulation scheme in a case where C/N satisfying the required C/N is obtained as a result of the enhancement of the C/N.

12. The wireless communication system according to claim 2, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

13. The wireless communication system according to claim 3, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

14. The wireless communication system according to claim 4, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

15. The wireless communication system according to claim 5, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

16. The wireless communication system according to claim 9, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

17. The wireless communication system according to claim 10, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.

18. The wireless communication system according to claim 11, wherein
the wireless communication device circuitry is configured to execute:
in a case where the unusable state is detected, calculating current C/N realized at that time; and
determining whether or not the current C/N satisfies required C/N necessary in a case where the another modulation scheme is used; and
the working modulation scheme is changed to the another modulation scheme in a case where the current C/N satisfies the required C/N.
